(19) United States
(12) Patent Application Publication
(10) Pub. No.: US 2013/0033911 A1
(43) Pub. Date: Feb. 7, 2013

(54) POWER CONVERTING APPARATUS

(71) Applicants: Yukio Mizukoshi, Machida-shi (JP); Yusuke Minagawa, Yokosuka-shi (JP)

(72) Inventors: Yukio Mizukoshi, Machida-shi (JP); Yusuke Minagawa, Yokosuka-shi (JP)

(73) Assignee: NISSAN MOTOR CO., LTD.

(21) Appl. No.: 13/640,903

(22) PCT Filed: Apr. 12, 2011
(86) PCT No.: PCT/JP2011/002159

§ 371 Date: Oct. 12, 2012

(30) Foreign Application Priority Data
Apr. 14, 2010 (JP) 2010-093149

(51) Int. Cl. H02M 7/537

(52) U.S. Cl. 363/131

(57) ABSTRACT

A power converting apparatus, includes: switching elements (S1 to S6) that are connected in parallel to a common bus bar and drive currents of different phases; and a motor controller (14) that controls the respective switching elements (S1 to S6). The motor controller (14) controls the respective switching elements (S1 to S6) in such a manner that a direction of a current fluctuation by an on/off operation of one switching element is opposite to a direction of a current fluctuation by an on/off operation of at least one of other switching elements.

### TECHNICAL FIELD

The present invention relates to a power converting apparatus for converting DC power to AC power, more preferably, relates to a technique for suppressing rapid current fluctuations so as to prevent high surge voltage applied to a switching element.

### BACKGROUND ART

A power converting apparatus for supplying power to drive a motor mounted on a vehicle controls to switch a plurality of switching elements on and off. Therefore, rapid current fluctuations are caused in a common bus bar connected to a DC power source, and high surge voltage (L*di/dt) derived from a parasitic inductance (L) is thus caused. In order to suppress such current fluctuations, the PTL 1 discloses a method for preventing rapid current fluctuations, in which drive timings of switching elements of a plurality of phases (for example, U-phase, V-phase and W-phase) are varied so as to prevent each switching element from turning on concurrently.

### CITATION LIST

### Patent Literature

PTL 1: International Publication WO 2005/081389

### SUMMARY OF INVENTION

### Technical Problem

According to the PTL 1, an increase in current variation (di/dt) can be prevented when current directions are identical and the switching elements turn on concurrently. However, when the respective switching elements turn on or off independently, rapid current fluctuations cannot be prevented.

The present invention has been made in view of such a conventional problem. It is an object of the present invention to provide a power converting apparatus capable of preventing rapid current fluctuations associated with on/off operations of each switching element.

### Solution to Problem

In order to achieve the above-mentioned object, a power converting apparatus according to the first aspect of the present invention comprises: a first switching element and a second switching element that are connected in parallel to a common bus bar and drive currents of different phases; and a control unit that controls on/off operations of the first and second switching elements, wherein the control unit controls the on/off operations in such a manner that a direction of a current fluctuation by the on/off operation of the first switching element is opposite to a direction of a current fluctuation by the on/off operation of the second switching element.

A power converting apparatus according to the second aspect of the present invention that converts DC power to be output from a DC power source into AC power, comprises: a first switching element and a second switching element that are connected in parallel to a pair of common bus bars connected to positive and negative electrodes of the DC power source, respectively, and drive currents of different phases; and a control unit that controls on/off operations of the first and second switching elements, wherein the control unit controls the on/off operations in such a manner that a direction of a current fluctuation by the on/off operation of the first switching element is opposite to a direction of a current fluctuation by the on/off operation of the second switching element.

### Advantageous Effect of Invention

The power converting apparatus of the present invention controls the switching elements in such a manner that a direction of current fluctuation when a switching element of one phase is operated is opposite to a direction of current fluctuation when an element of another phase is operated. Therefore, a variation of current that includes a parasitic inductance and passes through a current path can be reduced, and surge voltage derived from current fluctuations can be prevented.

### BRIEF DESCRIPTION OF DRAWINGS

FIG. 1 is a circuit diagram showing a constitution of a power converting apparatus according to the first embodiment of the present invention.

FIG. 2 is a block diagram showing a constitution of a motor control unit including a power converting apparatus according to the first embodiment of the present invention.

FIG. 3 is a timing chart showing a drive pulse generated in a power converting apparatus according to the first embodiment of the present invention and a shifted pulse from the drive pulse.

FIG. 4 is a timing chart showing current fluctuations of respective U-phase, V-phase and W-phase generated in a power converting apparatus according to the first embodiment of the present invention.

FIG. 5 is an explanatory diagram showing current immediately before a switching element of V-phase is shifted from an on-state to an off-state in a normal power converting apparatus.

FIG. 6 is an explanatory diagram showing current immediately after a switching element of V-phase is shifted from an on-state to an off-state in a normal power converting apparatus.

FIG. 7 is an explanatory diagram showing current fluctuations caused when a switching element of V-phase is shifted from an on-state to an off-state in a normal power converting apparatus.

FIG. 8 is an explanatory diagram showing fluctuations of current flowing into a capacitor when a switching element of V-phase is shifted from an on-state to an off-state in a normal power converting apparatus.

FIG. 9 is an explanatory diagram showing a direction and a magnitude of current flowing into a capacitor when a switching element of U-phase is shifted from an on-state to an off-state in a normal power converting apparatus.

FIG. 10 is an explanatory diagram showing a direction and a magnitude of current flowing into a capacitor when a switching element of U-phase is shifted from an off-state to an on-state in a normal power converting apparatus.

FIG. 11 is a diagram illustrating a process of generating a drive pulse according to a relationship between a carrier signal and a voltage directive value in a power converting apparatus according in a normal power converting apparatus.

FIG. 12 is a diagram illustrating a process of shifting a drive pulse generated according to a relationship between a carrier signal and a voltage directive value in a power converting apparatus according to the first embodiment of the present invention.

FIG. 13 is an explanatory diagram showing fluctuations of current flowing into a capacitor when a drive pulse is shifted and a drive pulse is not shifted.

FIG. 14 is an explanatory diagram typically showing an example of shifting a drive pulse so as to reduce current fluctuations in a power converting apparatus according to the first embodiment of the present invention.

FIG. 15 is an explanatory diagram typically showing an example of shifting a drive pulse so as to reduce current fluctuations in a power converting apparatus according to the first embodiment of the present invention.

FIG. 16 is an explanatory diagram showing current fluctuations of each phase when an inverter has nine phases in a power converting apparatus according to the first embodiment of the present invention.

FIG. 17 is an explanatory diagram showing current values and differences of each phase at a predetermined time when an inverter has nine phases in a power converting apparatus according to the first embodiment of the present invention.

FIG. 18 is a circuit diagram of an inverter when respective U-phase, V-phase and W-phase are divided into three systems in a power converting apparatus according to the second embodiment of the present invention.

FIG. 19 is a circuit diagram of an inverter when respective U-phase, V-phase and W-phase are divided into four systems in a power converting apparatus according to the second embodiment of the present invention.

FIG. 20 is a timing chart showing current fluctuations of respective U1, U2 and U3 when U-phase is divided into three systems in a power converting apparatus according to the second embodiment of the present invention.

FIG. 21 is an explanatory diagram showing drive pulses of respective U1, U2 and U3 when U-phase is divided into three systems in a power converting apparatus according to the second embodiment of the present invention.

FIG. 22 is an explanatory diagram in a case of shifting drive pulses of respective U1, U2 and U3 when U-phase is divided into three systems in a power converting apparatus according to the second embodiment of the present invention.

FIG. 23 is a timing chart showing current fluctuations of respective U1, U2, U3 and U4 when U-phase is divided into four systems in a power converting apparatus according to the second embodiment of the present invention.

FIG. 24 is an explanatory diagram in a case of shifting drive pulses of respective U1, U2, U3 and U4 when U-phase is divided into four systems in a power converting apparatus according to the second embodiment of the present invention.

FIG. 25 is an explanatory diagram in a case of dividing a drive pulse of W-phase into two drive pulses so as to correspond to an off timing of U-phase in a power converting apparatus according to the third embodiment of the present invention.

### DESCRIPTION OF EMBODIMENTS

The following is an explanation of an embodiment according to the present invention with reference to the drawings.

### First Embodiment

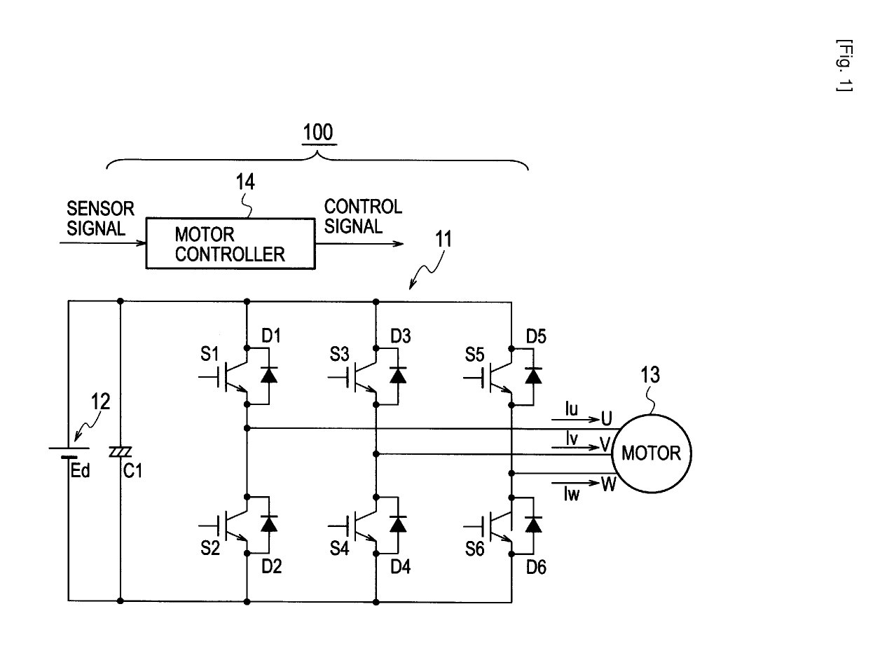

A constitution of a power converting apparatus 100 and a motor 13 driven by power supplied from the power converting apparatus 100 according to the first embodiment of the present invention will be explained with reference to FIG. 1. The present embodiment is an example of the power converting apparatus 100 that converts DC into three-phase AC. However, the converted AC is not limited to three-phase AC, and may be multiple-phase AC of four or more phases.

As shown in FIG. 1, the power converting apparatus 100 includes an inverter 11 and a motor controller (control unit, control means) 14.

The inverter 11 includes a DC power source 12, and a capacitor C1 connected to the DC power source 12. The inverter 11 further includes switching elements S1, S2, S3, S4, S5 and S6 using an IGBT (insulated gate bipolar transistor), and diodes D1, D2, D3, D4, D5 and D6 connected in inverse parallel to the respective switching elements S1 to S6. Each pair of the switching elements mutually connected in series, that is, each pair of S1 and S2, S3 and S4, and S5 and S6 is composed of an upper arm and a lower arm of each phase in the inverter 11. Note that, the switching elements are not limited to the IGBT.

An emitter of the switching element S1 is connected to a collector of the switching element S2. The connection point therebetween is an output point of U-phase of three-phase AC that is connected to the U-phase of the motor 13. Similarly, an emitter of the switching element S3 is connected to a collector of the switching element S4. The connection point therebetween is an output point of V-phase of three-phase AC that is connected to the V-phase of the motor 13. Similarly, an emitter of the switching element S5 is connected to a collector of the switching element S6. The connection point therebetween is an output point of W-phase of three-phase AC that is connected to the W-phase of the motor 13.

The respective collectors of the switching elements S1, S3 and S5 are connected to a positive electrode of the DC power source 12 via a common bus bar. The respective emitters of the switching elements S2, S4 and S6 are connected to a negative electrode of the DC power source 12 via a common bus bar. The pairs of the switching elements (S1 and S2, S3 and S4, S5 and S6) are connected in parallel to each common bus bar connected to the positive and negative electrodes of the DC power source 12, respectively. Each gate of the switching elements S1 to S6 is driven by a control signal being output from the motor controller 14. The pairs of the switching elements (S1 and S2, S3 and S4, S5 and S6) drive currents of the respective phases (U-phase, V-phase and W-phase).

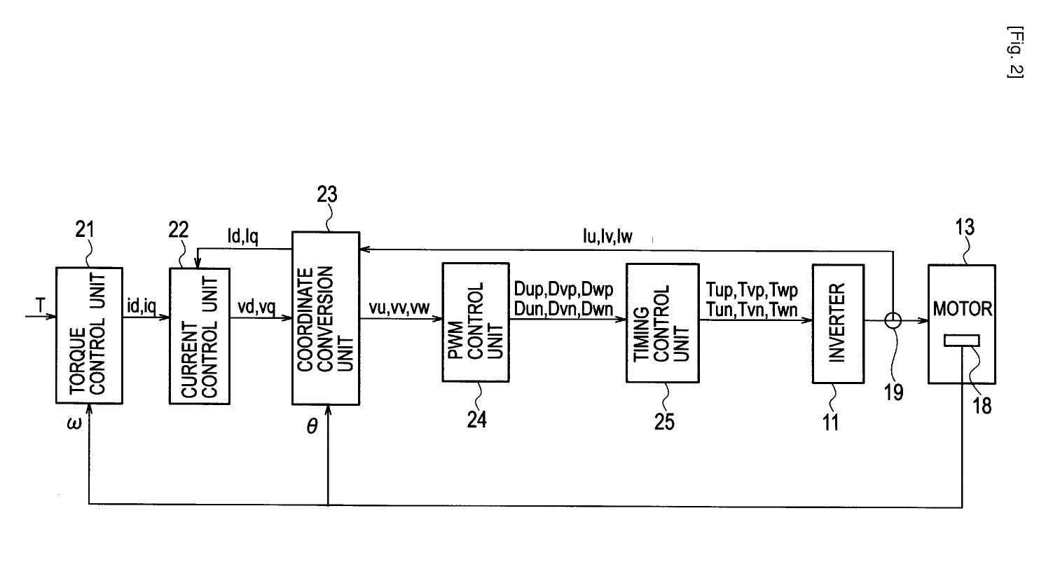

Based on load currents Iu, Iv and Iw of the respective phases flowing into the motor 13 detected by a current sensor (reference numeral 19 in FIG. 2), a rotation position of the motor 13 detected by a rotational frequency sensor (reference numeral 18 in FIG. 2), and a torque directive value provided by an upper apparatus not shown in the figure, the motor controller 14 generates control signals for controlling the switching elements S1 to S6 by PMW, followed by outputting to the gates of the respective switching elements S1 to S6.

The motor controller 14 according to the present embodiment is composed of, but not particularly limited to, a microprocessor including a central processing unit (CPU), a program ROM, a work RAM, and an input-output interface. The CPU executes a program stored in the ROM so that the motor controller 14 performs a control function.

Next, a specific constitution of the motor controller 14 (control unit, control means) for controlling the inverter 11 shown in FIG. 1 will be explained with reference to the block diagram shown in FIG. 2. As shown in FIG. 2, the motor controller 14 controls the motor 13 for driving a vehicle, for example. The motor controller 14 includes a torque control unit 21, a current control unit 22, a coordinate conversion unit 23 (voltage directive value setting unit), a PWM control unit 24 (duty cycle setting unit, PWM control unit), and a timing control unit 25 (timing setting unit). The motor controller 14 outputs a drive signal generated in the timing control unit 25 to the respective gates of the switching elements S1 to S6, so as to drive the inverter 11. The motor controller 14 also includes the current sensor 19 for detecting current flowing into the motor 13.

The torque control unit 21 calculates current directive values id and iq of a d-axis and a q-axis of the motor 13, respectively, based on a torque directive value T applied externally, and a motor rotation frequency Omega detected by the rotation frequency sensor 18 for detecting a rotation frequency of the motor 13.

Based on the current directive values id and iq of the d-axis and the q-axis and current values Id and Iq of the d-axis and the q-axis, the current control unit 22 calculates voltage directive values vd and vq of the d-axis and the q-axis, respectively, to conform the directive values to the actual values. With regard to the calculation of the current values Id and Iq of the d-axis and the q-axis, currents iu, iv and iw of the respective phases (U-phase, V-phase and W-phase) of the motor 13 are detected by the current sensor 19, followed by converting to the current values Id and Iq of the d-axis and the q-axis by the coordinate conversion unit 23. Note that, a sum of the currents of the respective phases of the motor 13 is zero. Thus, the currents iu and iv of at least the two phases are detected, so that the currents iu, iv and iw of the three phases of the motor 13 can be obtained.

The coordinate conversion unit 23 converts the voltage directive values vd and vq of the d-axis and the q-axis to voltage directive values vu, vv and vw of the three phases.

The PWM control unit 24 generates drive pulses Dup, Dun, Dvp, Dvn, Dwp and Dwn of the inverter 11 corresponding to the respective voltage directive values vn, vv and vw of the U-phase, V-phase and W-phase being output from the coordinate conversion unit 23, so as to output to the timing control unit 25. The present embodiment is not limited to the voltage directive values, and the current directive values may be used.

The timing control unit 25 generates drive pulses Tup, Tun, Tvp, Tvn, Twp and Twn in which the timings for controlling the on/off operations of the respective switching elements S1 to S6 provided in the inverter 11 are changed by means of a method described below, so as to output the drive pulses to the inverter 11. Tup and Tun represent the drive pulses supplied to the upper and lower switching elements S1 and S2 of the U-phase, Tvp and Tvn represent the drive pulses supplied to the upper and lower switching elements S3 and S4 of the V-phase, and Twp and Twn represent the drive pulses supplied to the upper and lower switching elements S5 and S6 of the W-phase.

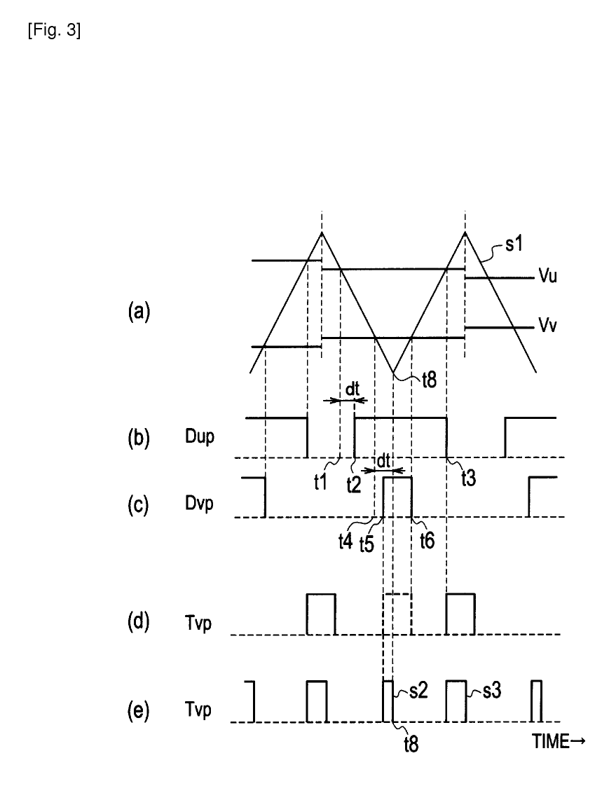

Next, a process of generating the drive pulses Dup, Dun, Dvp, Dvn, Dwp and Dwn from the voltage directive values vn, vv and vw of the three phases to be output to the respective switching elements S1 to S6 by the PWM control unit 24 shown in FIG. 2 will be explained with reference to the timing chart shown in FIG. 3. Note that, FIG. 3 shows only the case of generating the drive pulses Dup and Dvp of the upper arms from the voltage directive values vu and vv of the two phases, in view of the promotion of better understanding.

When a carrier signal s1 of a triangle wave shown in FIG. 3(a) is supplied, the PWM control unit 24 compares the carrier signal s1 with each voltage directive value vu and vv. Then, the PWM control unit 24 generates the drive pulse to be turned on at a period of time when the voltage directive value is larger than the carrier signal s1 and to be turned off at a period of time when the voltage directive value is smaller than the carrier signal s1 with regard to the upper arm. Also, the PWM control unit 24 generates the drive pulse to be turned on at a period of time when the voltage directive value is smaller than the carrier signal s1 and to be turned off at a period of time when the voltage directive value is larger than the carrier signal s1 with regard to the lower arm. Further, the PWM control unit 24 provides a dead time by delaying the time at which the drive pulse is shifted from the off-state to the on-state. Accordingly, an occurrence of short circuit of the upper and lower arms can be prevented due to the provision of the dead time.

The drive pulse Dup is turned on at the time t2 that is delayed dt from the time t1 as shown in FIG. 3(b) since the voltage directive value vu of the upper arm of the U-phase exceeds the carrier signal s1 at the time t1. Then, the drive pulse Dup is turned off at the time t3 since the voltage directive value vu falls below the carrier signal s1 at the time t3. Namely, the drive pulse Dup as shown in FIG. 3(b) is generated.

Similarly, the drive pulse Dvp is turned on at the time t5 that is delayed dt from the time t4 as shown in FIG. 3(c) since the voltage directive value vv of the upper arm of the V-phase exceeds the carrier signal s1 at the time t4. Then, the drive pulse Dvp is turned off at the time t6 since the voltage directive value vv falls below the carrier signal s1 at the time t6. Namely, the drive pulse Dvp as shown in FIG. 3(c) is generated. Note that, the similar condition is also applied to the case of the voltage directive value vw of the W-phase, and this case is not shown in FIG. 3.

Next, a first process of generating the drive pulses Tup, Tun, Tvp, Tvn, Twp and Twn by shifting the phases of the respective drive pulses Dup, Dun, Dvp, Dvn, Dwp and Dwn by the timing control unit 25 shown in FIG. 2 will be explained. The following is an example of generating the drive pulse Tvp by shifting the timing of the drive pulse Dvp of the upper arm of the V-phase. In other words, the phase of the drive pulse Dvp shown in FIG. 3(c) is shifted so as to generate the drive pulse Tvp as shown in FIG. 3(d).

The following is an explanation of the shifting process of the drive pulse. When the voltage directive value vv exceeds the carrier signal s1 at the time t4, the drive pulse

Tvp is controlled so as not to be on at the time t5 after a lapse of dt. The time until the voltage directive value vv falls below the carrier signal s1, that is, the time between the time t5 and the time t6 (duty width) is obtained so as to store the duty width. Then, the drive pulse Tvp is controlled to be on at the time t3 at which the drive pulse Dup is off. The on-state of the drive pulse Tvp is kept during the above-mentioned duty width, and then, the drive pulse Tvp is turned off. As a result, the drive pulse Tvp is to be shifted to the drive pulse shown in FIG. 3(d). Then, a decay time of the drive pulse Dup (timing to be off) is controlled so as to correspond to a rise time of the drive pulse Tvp (timing to be on). This is because both currents (currents different in direction) are mutually counterbalanced, and current flowing into a capacitor C1 shown in FIG. 1 is reduced. The more specific explanation will be described below.

Next, a second process of generating the drive pulses Tup, Tun, Tvp, Tvn, Twp and Twn by shifting the phases of the respective drive pulses Dup, Dun, Dvp, Dvn, Dwp and Dwn by the timing control unit 25 shown in FIG. 2 will be explained. The following is an example of dividing the drive pulse Dvp shown in FIG. 3(c) and shifting a phase of at least one of the divided drive pulses, so as to change to two drive pulses indicated by the reference numerals s2 and s3 shown in FIG. 3(e).

The following is an explanation of the shifting process of the drive pulse. When the voltage directive value vv exceeds the carrier signal s1 at the time t4, the drive pulse Tvp is controlled so as to be on at the time t5 after a lapse of dt. Then, the drive pulse Tvp is controlled to be off at the time t8 at which the carrier signal s1 reaches the lowest point. As a result, the drive pulse indicated by the reference numeral s2 in FIG. 3(e) is generated. Then, the time from the point at which the voltage directive value vv exceeds the carrier signal s1 to the point at which the voltage signal vv falls below the carrier signal s1, that is, the time between the time t5 and the time t6 (duty width) is obtained, thereby storing the duty width. The drive pulse Tvp is controlled to be on again at the time t3 at which the drive pulse Dup is off. The on-state of the drive pulse Tvp is kept only during the time obtained by subtracting the time between the time t5 and the time t8 (drive pulse s2) from the duty width, and then the drive pulse Tvp is controlled to be off. Alternatively, the time between the time t8 and the time t6 (duty width) may be stored, so as to determine the time of being on from the time t3. As a result, the drive pulse Tvp is changed to the two drive pulses s2 and s3 shown in FIG. 3(e). In this case, a sum of the pulse widths of the two drive pulses s2 and s3 is identical to the drive pulse width between the time t5 and the time t6 shown in FIG. 3(c).

With regard to the drive pulse Tvp shown in FIG. 3(d), the drive pulse between the time t5 and the time t6 straddles the time t8. On the other hand, the drive pulse to be generated in the second process does not straddle the boundary (time t8) of the carrier signal s1, unlike the above-mentioned first process. Therefore, there is an advantage of preventing a degradation of a synchronous performance with the carrier signal.

As described above, FIG. 3 is the example of controlling the timings of the drive pulses of the U-phase and the V-phase so as to correspond to each other. Similarly, the timings of the drive pulses between the other two phases may be controlled to correspond to each other. When the drive pulses of the three phases are controlled to be identical, the similar idea to the case of the timing adjustment between the two phases may be applied. For example, each rising edge of the drive pulses of the V-phase and the W-phase may be controlled so as to correspond to a trailing edge of the drive pulse of the U-phase.

The following is an explanation of the purpose of corresponding the rising edge of one drive pulse to the trailing edge of another drive pulse, as shown in FIGS. 3(d) and 3(e).

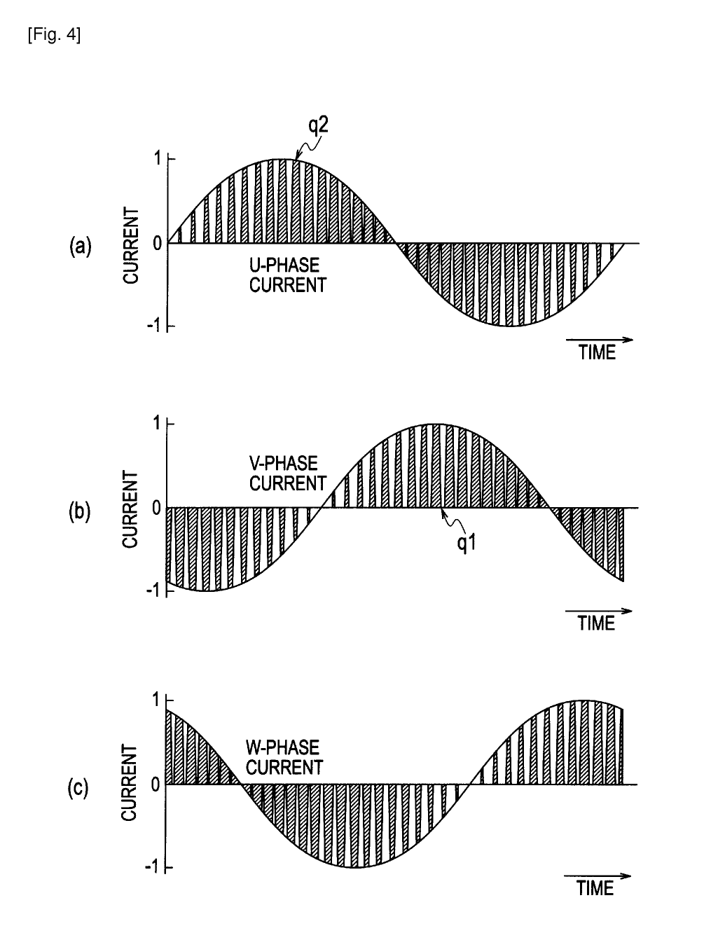

FIGS. 4(a) to 4(c) are the respective timing charts showing the on/off operations of the switching elements S1 to S6 provided in the respective U-phase, the V-phase and the W-phase. The white areas in the timing charts represent the timings at which the upper switching elements S1, S3 and S5 are on, and the shaded areas represent the timings at which the lower switching elements S2, S4 and S6 are on. A waveform of the respective phases is a sinusoidal waveform in which each phase is shifted by 120 degrees.

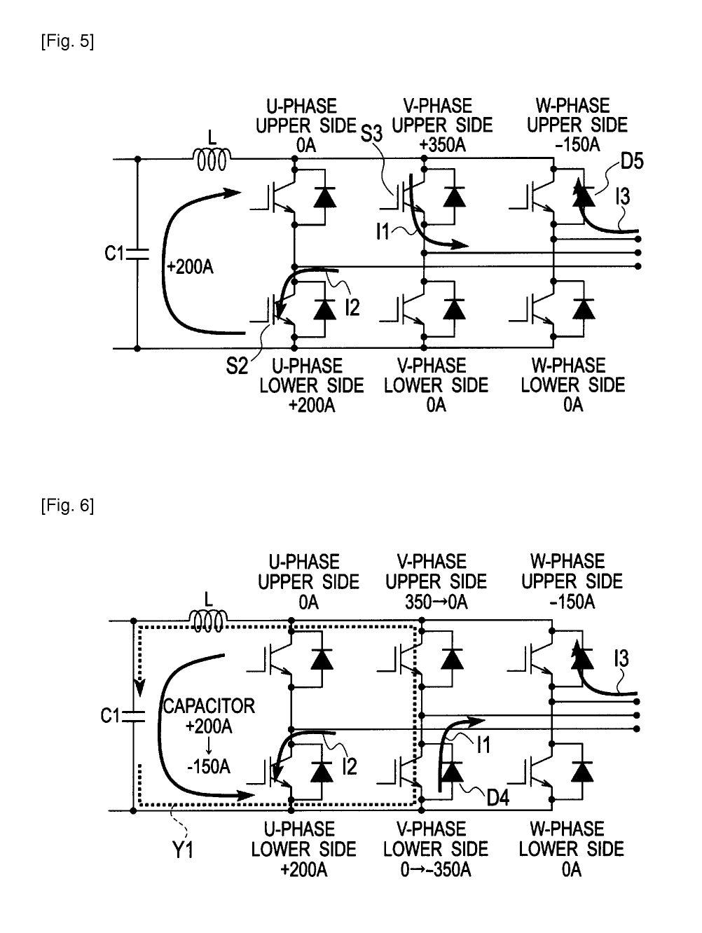

At the timing immediately before the upper switching element S3 of the V-phase is turned off indicated by the reference numeral q1 shown in FIG. 4(b), currents flow in the respective phases as shown in FIG. 5. Namely, a current I1 of +350 A flows in the upper switching element S3 of the V-phase, a current I2 of +200 A flows in the lower switching element S2 of the U-phase, and a current I3 of −150 A flows in the upper diode D5 of the W-phase. With regard to the current directions, a forward direction of the respective switching elements S1 to S6 is defined as a plus current, and an inverse direction is defined as a minus current.

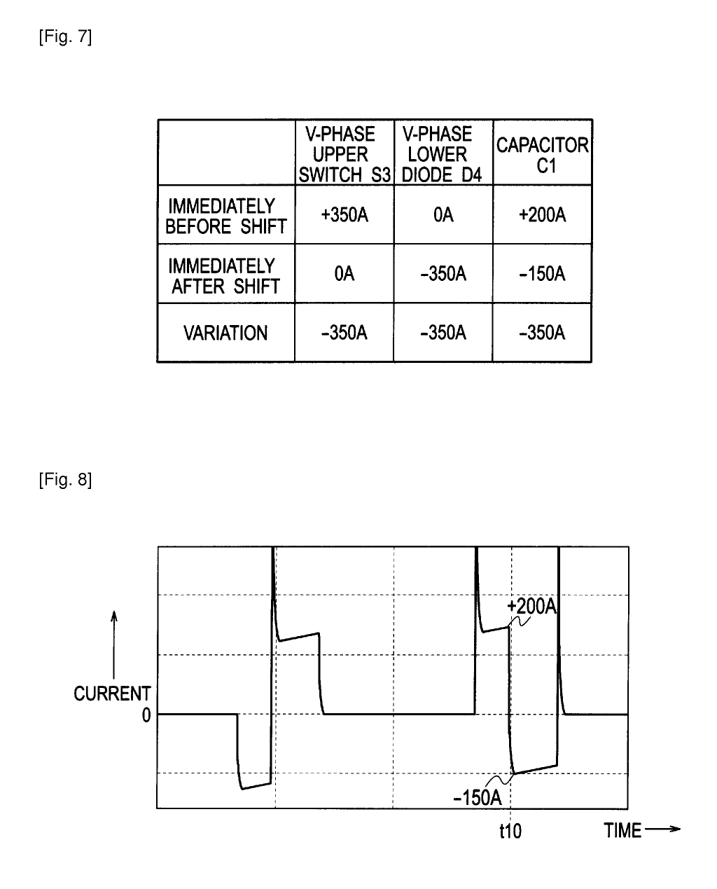

The upper switching element S3 of the V-phase is then shifted from the on-state to the off state, thereby shifting to a free-wheeling mode. Accordingly, the lower diode D4 of the V-phase is shifted to the on-state as shown in FIG. 6, so that the current I1 keeps flowing toward the motor 13 (right direction in the figure). FIG. 7 shows current fluctuations at the moment when the upper switching element S3 of the V-phase is shifted from the on-state to the off-state.

Namely, as shown in FIG. 7, when the upper switching element S3 of the V-phase is shifted from the on-state to the off-state, the same current fluctuation equivalent to −350 A is caused at the upper switching element S3 of the V-phase, the lower diode D4 of the V-phase, and the capacitor C1, respectively. With respect to the upper and lower arm bridges of the U-phase and the upper and lower arm bridges of the W-phase, there is no change of the switching operation (no current fluctuation) at the moment when the switching element S3 is shifted from the on-state to the off-state. Meanwhile, a rapid current fluctuation derived from the switching operation of the V-phase is caused in a circuit loop indicated by an arrow Y1 in FIG. 6.

FIG. 8 is a timing chart showing fluctuations of current flowing into the capacitor C1 at the moment when the switching element S3 is shifted from the on-state to the off-state. The current flowing into the capacitor C1 is shifted from +200 A to −150 A at the time t10. As a result, high surge voltage (L*di/dt) derived from a parasitic inductance L in the current pathway is caused.

According to the present embodiment, the drive timings of the switching elements S1 to S6 of the respective phases are shifted so as to reduce rapid fluctuations of current flowing into the capacitor C1. Accordingly, surge voltage derived from the parasitic inductance L is prevented. In other words, as described above with reference to FIG. 3, the rising edge of the drive pulse of one phase is synchronized with the trailing edge of the drive pulse of another phase, so that the rapid fluctuations of current flowing into the capacitor C1 is reduced to prevent the surge voltage.

The following is an explanation of the process to synchronize the operations of the switching elements having current fluctuations in the different directions from each other, so as to counteract the current fluctuations.

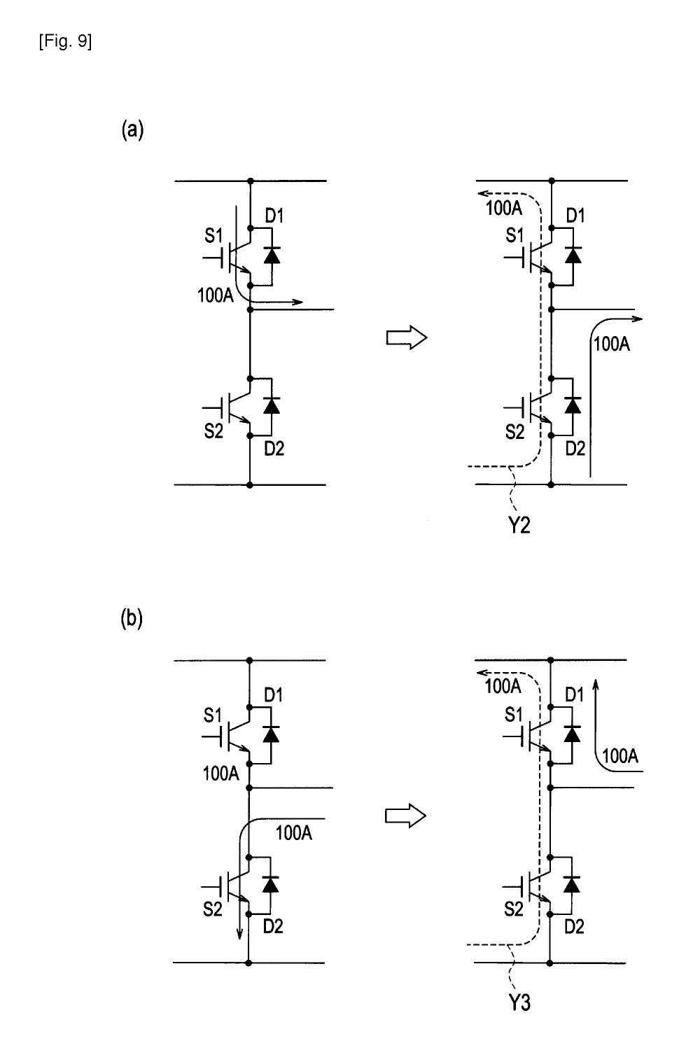

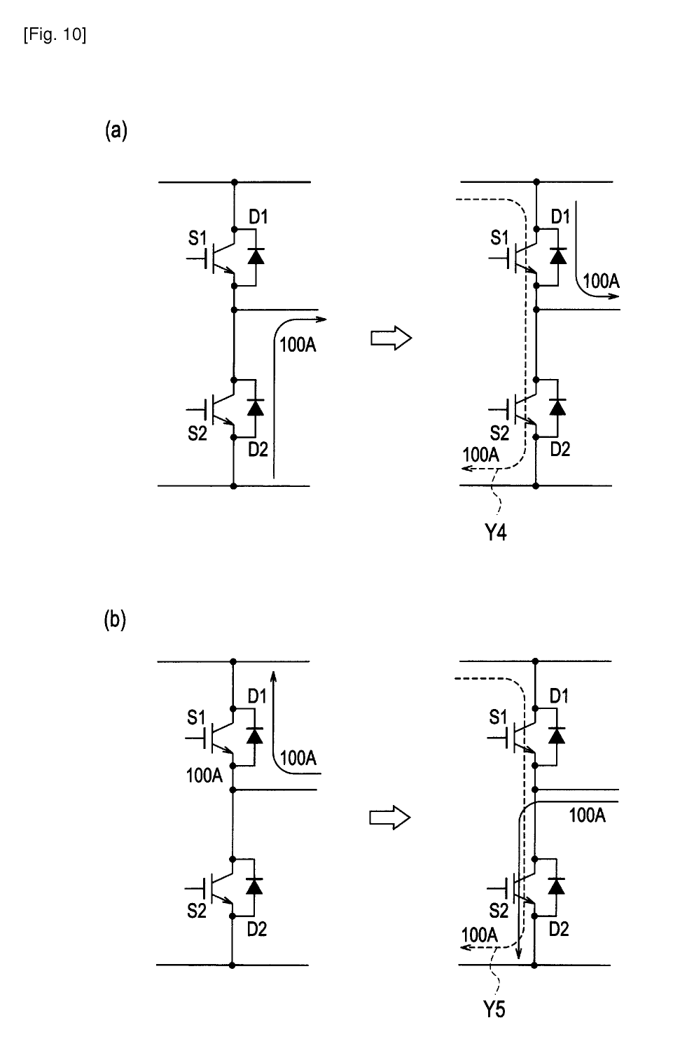

FIGS. 9(a) and 9(b) and FIGS. 10(a) and 10(b) are explanatory diagrams showing operation examples of the respective switching elements S1 and S2 of the U-phase. The respective figures are circuits partially showing the section of the switching elements S1 and S2 of the U-phase provided in the inverter 11. The middle point between the upper arm and the lower arm is connected to the U-phase input terminal of the motor 13. The arrows toward the right direction in the figures represent current flows toward the motor 13, namely, represent plus current flows, and the arrows toward the left direction represent current flows from the motor 13, namely, represent minus current flows.

FIG. 9(a) shows a plus current flow toward the motor 13 in the U-phase, and a current fluctuation at the moment when the upper switching element S1 is shifted from the on-state to the off-state. In this case, the current flowing toward the motor 13 from the plus side (DC high potential side) of the DC power source 12 shown in FIG. 1 is interrupted since the switching element S1 is shifted to the off-state, thereby shifting to the free-wheeling mode from the DC low potential side. As a result, the current flows toward the motor 13. This is equivalent to the occurrence of the current fluctuation indicated by an arrow Y2 in this moment.

FIG. 9(b) shows a minus current flow toward the motor 13 in the U-phase, and a current fluctuation at the moment when the lower switching element S2 is shifted from the on-state to the off-state. Similar to the case of FIG. 9(a), the current fluctuation indicated by an arrow Y3 is caused at the moment when the switching element S2 is shifted from the on-state to the off-state. In other words, in the cases of FIGS. 9(a) and 9(b), it is recognized that the current fluctuations in the counterclockwise direction (arrows Y2 and Y3) are generated. Such current fluctuations are generated in the U-phase, the V-phase and the W-phase, respectively.

On the other hand, FIG. 10(a) shows a state in which the upper switching element S1 of the U-phase is in the off-state and the current flows toward the motor 13 from the lower diode D2, and also shows a current fluctuation at the moment when the switching element S1 is shifted from the off-state to the on-state. FIG. 10(b) shows a state in which the lower switching element S2 of the U-phase is in the off-state, and a current fluctuation at the moment when the switching element is shifted from the off-state to the on-state. In other words, in the cases of FIGS. 10(a) and 10(b), it is recognized that the current fluctuations in the clockwise direction (arrows Y4 and Y5) are generated. Such current fluctuations are generated in the U-phase, the V-phase and the W-phase, respectively.

Therefore, it is recognized that the timing of one of FIGS. 9(a) and 9(b) is synchronized with the timing of one of FIGS. 10(a) and 10(b), so as to counteract or reduce the currents indicated by the arrows Y2 to Y5.

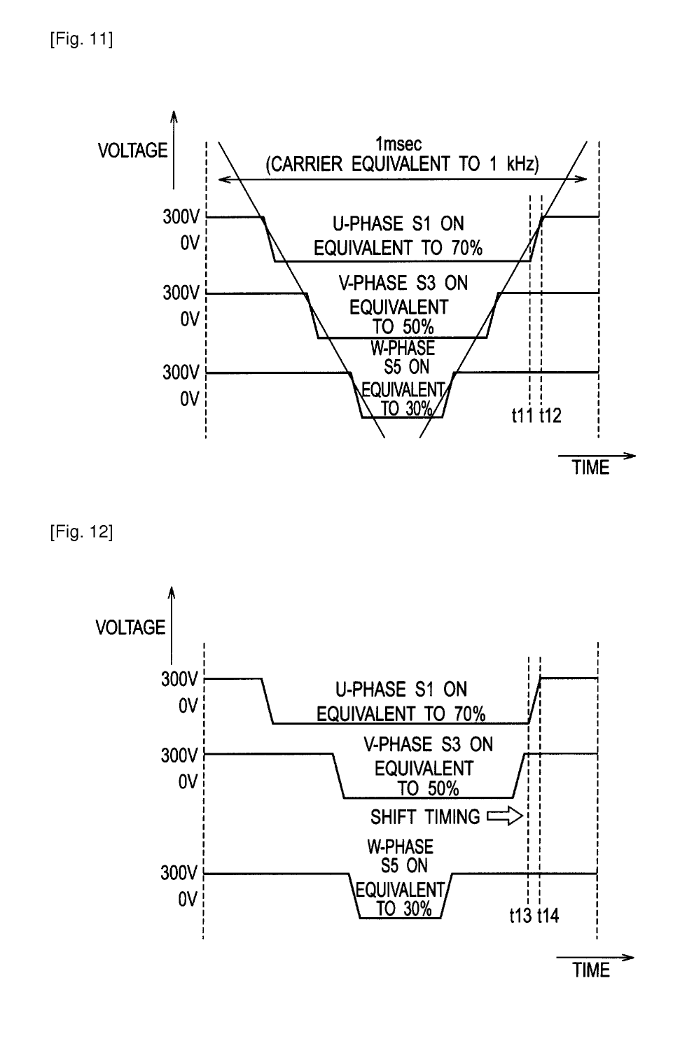

The following is an explanation of a process of generating the drive pulses to be output to the respective switching elements S1 to S6. First, a conventionally-employed normal operation will be explained. FIG. 11 is an explanatory diagram showing a process of determining pulse widths of the drive signals for PWM controlling of the respective phases, according to the carrier signal having a predetermined carrier frequency (for example, 1 [KHz]) and the voltage directive values of the respective U-phase, V-phase and W-phase. FIG. 11 shows a case in which the timing shift process according to the present invention is not applied. Due to such a process, the pulse widths of the pulse signals to be output to the upper switching elements S1, S3 and S5 of the respective U-phase, V-phase and W-phase are determined. The lower switching elements S2, S4 and S6 operate inversely with the upper switching elements S1, S3 and S5, respectively. For example, S2 is in the off-state when S1 is in the on-state, and S1 is in the off-state when S2 is in the on-state.

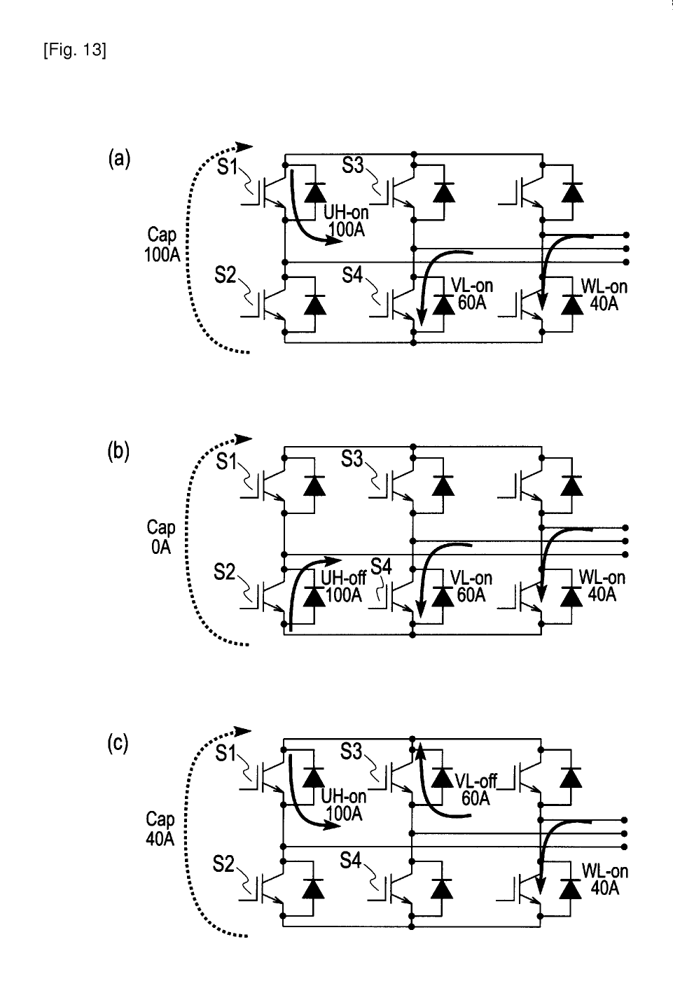

As shown in FIG. 11, the similar operation to FIG. 9(a) is performed when the state in which the upper switching element S1 of the U-phase is in the on-state (time t11, voltage 0 V) is shifted to the state in which the switching element S1 is turned off (time t12, voltage 300 V). During this time, a current of 100 A flows in the counter-clockwise direction in the circuit loop including the upper and lower arm bridges of the U-phase and the capacitor C1. Namely, since the state shown in FIG. 13(a) is shifted to the state shown in FIG. 13(b), the capacitor current Cap is shifted from 100 A to 0 A. As a result, surge voltage is caused by the inductance L parasitizing the circuit loop.

On the other hand, the present invention changes the timing in which the upper switching element S3 of the V-phase is shifted from the on-state to the off-state. In other words, when the timing shift process according to the present invention is employed, the similar operation to FIG. 9(a) is performed when the state in which the upper switching element S1 of the U-phase is in the on-state (time t13) is shifted to the state in which the switching element S1 is in the off-state (time t14). Thus, the timings of the switching elements S3 and S4 are shifted to correspond to such timings in the U-phase so that the lower switching element S4 of the V-phase is turned on and the upper switching element S3 of the V-phase is turned off. FIG. 12 shows a voltage waveform of the upper switching element S3 of the V-phase without showing a voltage waveform of the lower switching element S4 of the V-phase. As described above, the voltage waveform of the switching element S4 is opposite to the voltage waveform of the switching element S3.

Therefore, the lower switching element S4 of the V-phase is turned on after the upper switching element S3 of the V-phase is turned off. In this case, the switching element S4 is shifted from the off-state (t13 in FIG. 12) to the on-state (t14 in FIG. 12), and the similar operation to FIG. 10(b) is performed. When the state shown in FIG. 13(b) is shifted to the state shown in FIG. 13(c), a current fluctuation of 60 A is caused in the clockwise direction in the circuit loop including the upper and lower arm bridges of the V-phase and the capacitor C1.

At the same time, the current fluctuation of 100 A is caused in the counterclockwise direction in the circuit loop including the upper and lower arm bridges of the U-phase and the capacitor C1. Therefore, the directions of the respective current fluctuations are opposite to each other, and a current of 100 A in the counterclockwise direction is counteracted by a current of 60 A in the clockwise direction, so that the current fluctuation can be reduced to 40 A in the counterclockwise direction. The capacitor current Cap is shifted from 40 A to 0 A. Namely, at the moment when the upper switching element S1 of the U-phase is shifted from the on-state to the off-state and also when the lower switching element S4 of the V-phase is shifted from the off-state to the on-state, the state shown in FIG. 13(c) is shifted to the state shown in FIG. 13(b). Therefore, the current fluctuation can be reduced to 40 A, compared with the case in which the timing shift process is not performed. Accordingly, surge voltage caused by the parasitic inductance L in the circuit loop can be reduced.

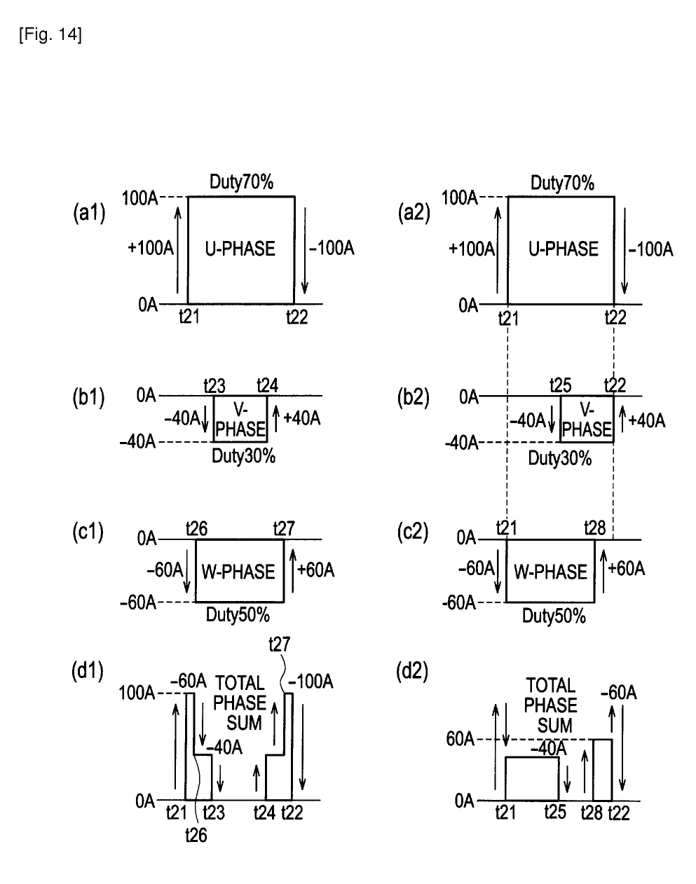

Next, the current fluctuations in the respective cases of FIG. 11 and FIG. 12 will be explained with reference to the schematic diagram shown in FIG. 14. FIG. 14 shows fluctuations of currents flowing in the respective U-phase, V-phase and W-phase during the time indicated by the reference numeral q2 in the three-phase AC waveforms shown in FIG. 4, and shows the respective current pulses before the phases are shifted (left side in the figure) and after the phases are shifted (right side in the figure). In addition, FIG. 14 shows the case in which the U-phase is the duty cycle of 70%, the V-phase is the duty cycle of 30%, and the W-phase is the duty cycle of 50%.

FIG. 14(a1) shows the current pulse of the U-phase, which is turned on at the time t21 so that a current of +100 A flows, and is turned off at the time t22 so that a current fluctuation of −100 A is generated. In the case of not shifting the phases, the current pulse of the V-phase is turned off at the time t23 so that a current of −40 A flows, and is turned on at the time t24 so that a current fluctuation of +40 A is generated, as shown in FIG. 14(b1). Moreover, the current pulse of the W-phase is turned off at the time t26 so that a current of −60 A flows, and is turned on at the time t27 so that a current fluctuation of +60 A is generated, as shown in FIG. 14(c1).

FIG. 14(d1) is the current pulse showing the case of adding up the currents of the respective phases. Namely, the current fluctuation of −60 A is generated at the time t26, the current fluctuation of −40 A is generated at the time t23, the current fluctuation of +40 A is generated at the time t24, the current fluctuation of +60 A is generated at the time t27, and the current fluctuation of −100 A is generated at the time t22. In this case, the maximum current fluctuation is between +100 A and −100 A.

On the other hand, in the case of shifting the phases according to the present invention, the current pulse of the V-phase is shifted to the right side so that the timing at the time t24 in FIG. 14(b1) corresponds to the timing at the time t22 as shown in FIG. 14(b2). In addition, the current pulse of the W-phase is shifted to the left side so that the timing at the time t26 in FIG. 14(c1) corresponds to the timing at the time t21 as shown in FIG. 14(c2). Thus, the current pulse of the W-phase is the pulse signal between the time t21 to the time t28. Note that, the current pulse of the U-phase shown in FIG. 14(a2) is identical to the current pulse in FIG. 14(a1).

FIG. 14(d2) is the current pulse showing the case of adding up the currents of the respective phases. Thus, the current fluctuation of −40 A is generated at the time t25, the current fluctuation of +60 A is generated at the time t28, and the current fluctuation of −60 A is generated at the time t22. In this case, the maximum current fluctuation is +60 A and −60 A. It is recognized that the current flowing in the clockwise direction and the current flowing in the counterclockwise direction are mutually counterbalanced to counteract the currents, thereby preventing a current flow into the capacitor C1.

In the case shown in FIG. 14, the drive pulse of the phase with a small duty cycle (V-phase, W-phase) is shifted to correspond to the drive pulse of the phase with a relatively large duty cycle (U-phase). In other words, when the switching element of the U-phase is defined as a first switching element, and the switching element of the V-phase or W-phase is defined as a second switching element, the output timing of the drive pulse of the second switching element is shifted so that an on-timing of the second switching element corresponds to an off-timing of the first switching element.

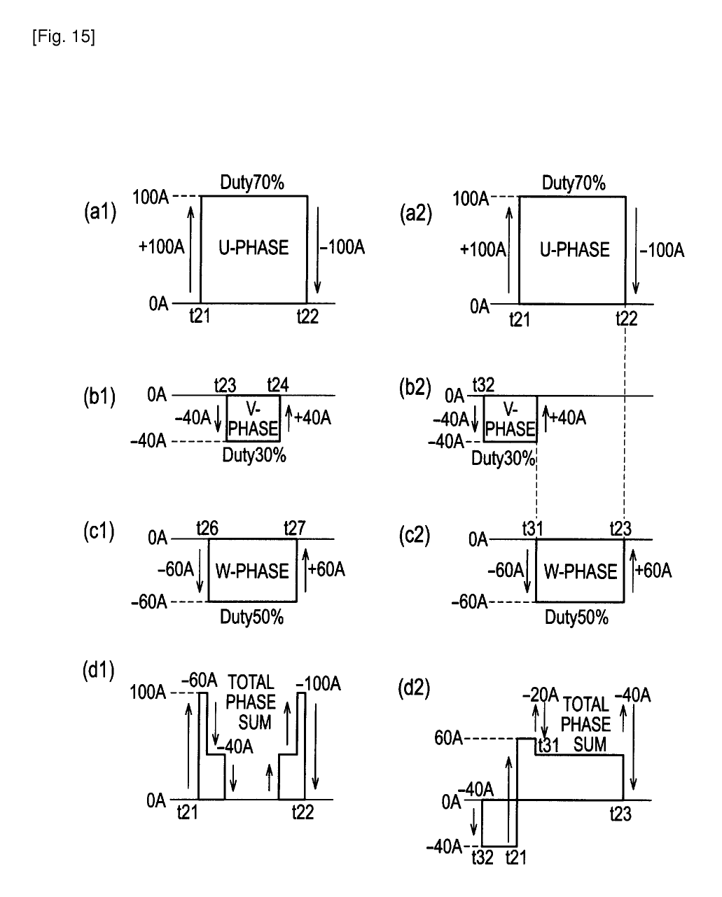

When the on-timing and the off-timing are synchronized between the phases with a small difference of the current values, the currents can be counteracted more effectively. The following is an explanation of this mechanism with reference to the typical diagram of the current pulses shown in FIG. 15. In the case of FIG. 14, the respective timings (time t22) of −100 A of the U-phase and +40 A of the V-phase are synchronized. In the case of FIG. 15, the respective timings of −100 A of the U-phase and +60 A of the W-phase are synchronized so that the respective currents are closer to each other.

As shown in FIGS. 15(b2) and 15(c2), the time when the W-phase is turned on is shifted from the time t27 to the time t23 so that the time when the U-phase is turned off corresponds to the time when the W-phase is turned on. In addition, the current pulse of the V-phase is shifted so that the time t31 when the W-phase is turned off defined by the time t23 corresponds to the time when the V-phase is turned on. In this case, the time when the V-phase is turned off is the time t32.

When the above-described phase shifts are performed, the current fluctuation of −40 A is generated at the time t32, the current fluctuation of −20 A is generated at the time t31, and the current fluctuation of −40 A is generated at the time t23, as shown in FIG. 15(d2). Note that, the waveforms shown in FIGS. 15(a1) to 15(d1) and FIG. 15(a2) are identical to those shown in FIGS. 14(a1) to 14(d1) and FIG. 14(a2).

Accordingly, the maximum current fluctuation in the minus current (counterclockwise) direction caused by surge voltage is −40 A. Thus, it is recognized that the reduction effect of the current fluctuations is further enhanced compared with the case of the maximum current fluctuation of −60 A shown in FIG. 14

As described above, the power converting apparatus 100 according to the first embodiment controls the switching elements in such a manner that the direction of the current fluctuation generated when the switching elements of one phase (for example, U-phase) are operated is opposite to the direction of the current fluctuation generated when the switching elements of another phase (for example, W-phase) are operated. Therefore, fluctuations of current flowing in the current pathway including the parasitic inductance L can be reduced. Accordingly, surge voltage caused by the current fluctuations can be prevented while maintaining a desired demand output.

Moreover, the power converting apparatus using the inverter circuit can easily change the output timings of the drive pulses of the respective phases without changing the duty cycles of the drive pulses. Thus, a control and operation load of the timing controller 25 can be reduced.

As shown in FIG. 14(b2) and FIG. 15(c2), when one switching element (for example,

V-phase) is turned on, another switching element (for example, U-phase), in which larger current flows compared with the former switching element, is controlled to be turned off. Therefore, surge voltage generated in the respective U-phase, V-phase and W-phase can be prevented.

Further, as shown in FIGS. 14(a2) and 14(b2), the rising edge of the drive pulse of the phase in which the ON time is short (V-phase) is controlled to correspond to the trailing edge of the drive pulse of the phase in which the ON time is long (U-phase), so that an influence on motor output can be suppressed. In other words, when the drive pulse of which the ON time is short is shifted, the drive pulse barely crosses over the boundary of the carrier period. Therefore, a degradation of a synchronous performance with the carrier signal can be prevented.

### Modified Example of First Embodiments

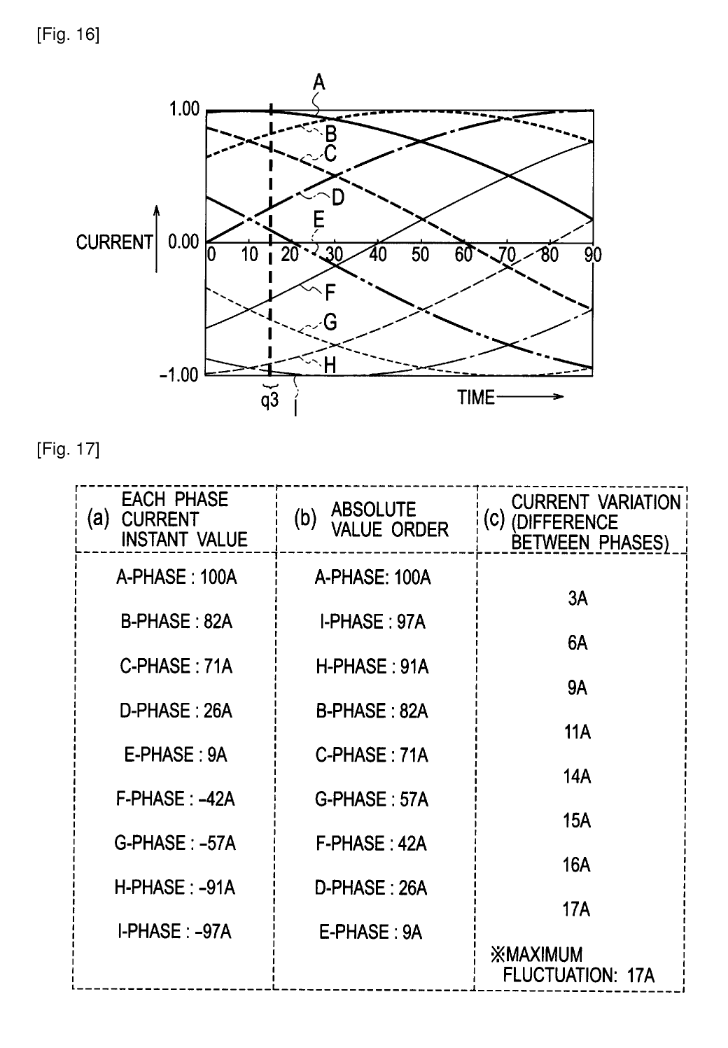

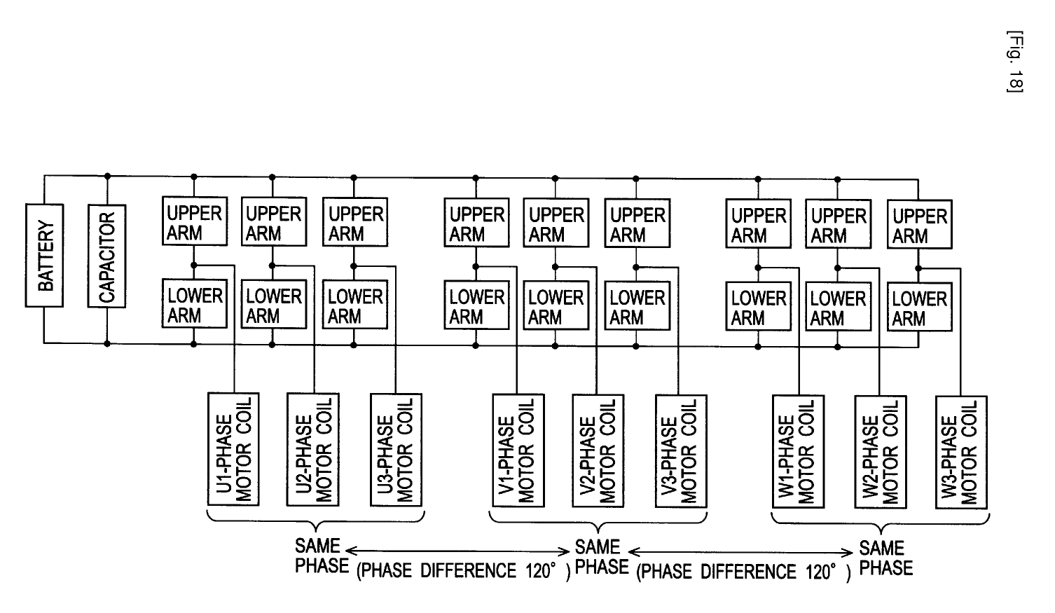

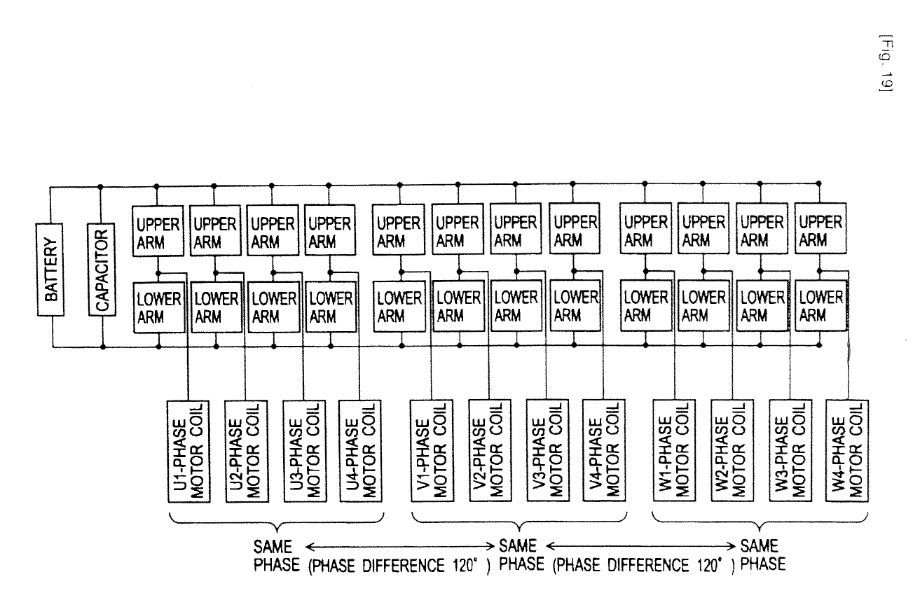

The following is a modified example of the above-described first embodiment. In the modified example, the inverter is composed of multiple phases, so as to improve an effect of preventing current fluctuations. FIG. 16 is a waveform showing current fluctuations of a nine-phase inverter that is composed of A-phase to I-phase. The current values of the respective phases at the point indicated by the reference numeral q3 in FIG. 16 are shown in FIG. 17(a). That is, the A-phase is a current of 100 A, the B-phase is a current of 82 A, the C-phase is a current of 71 A, the D-phase is a current of 26 A, the E-phase is a current of 9 A, the F-phase is a current of −42 A, the G-phase is a current of −57 A, the H-phase is a current of −91 A, and the I-phase is a current of −97 A.

When the absolute values of the current values of the respective phases shown in FIG. 17(a) are rearranged in descending order, the largest value is the A-phase, followed by the I-phase, the H-phase, the B-phase, the C-phase, the G-phase, the F-phase, the D-phase and the E-phase. It is recognized that the differences of the current values between the respective adjacent phases are smaller in the nine-phase case compared with the above-described three-phase case. Thus, the on-timing and the off-timing are synchronized between the respective two phases of which the absolute values are close to each other, so that the current fluctuations can be further reduced.

For example, when −100 A (off) of the A-phase is controlled to correspond to +97 A (on) of the I-phase, the current fluctuation derived from surge voltage can be reduced to −3 A. When −97 A (off) of the I-phase is controlled to correspond to +91 A (on) of the H-phase, the current fluctuation can be reduced to −6 A. The maximum difference in the two current values between the respective two phases is caused between the off-timing of the D-phase and the on-timing of the E-phase, and the maximum current fluctuation is −17 A. Namely, the current fluctuation can be reduced to −17 A. Accordingly, as the number of the phases composed of the inverter increases, the effect of preventing current fluctuations can be further achieved.

### Second Embodiment

Next, the power converting apparatus 100 of the second embodiment according to the present invention will be described. According to the above-described first embodiment, the U-phase, the V-phase and the W-phase include the switching elements of one system, respectively. On the other hand, the power converting apparatus according to the second embodiment includes switching elements of two or more systems that are connected in parallel to a common bus bar and that drive currents for each phase, respectively. More specifically, the power converting apparatus includes the switching elements of a plurality of systems for each phase, that is, three systems for one phase in the case of FIG. 18, and four systems for one phase in the case of FIG. 19, in which on/off timings of drive pulses to drive the switching elements of the respective systems in each phase are shifted so as to prevent current fluctuations. FIG. 18 is one example in which an inverter circuit including three systems for each of three phases is used to drive a 9-slot motor, and FIG. 19 is an example in which an inverter circuit including four systems for each of the three phases is used to drive a 12-slot motor.

When the drive pulses are shifted between the phases so as to counteract current fluctuations, the current fluctuations cannot be completely counteracted since currents of the respective phases change with time. In view of this, according to the second embodiment, a plurality of drive pulses are generated in each phase, and phases of the drive pulses are shifted in each phase, so that the current fluctuations are suppressed more effectively.

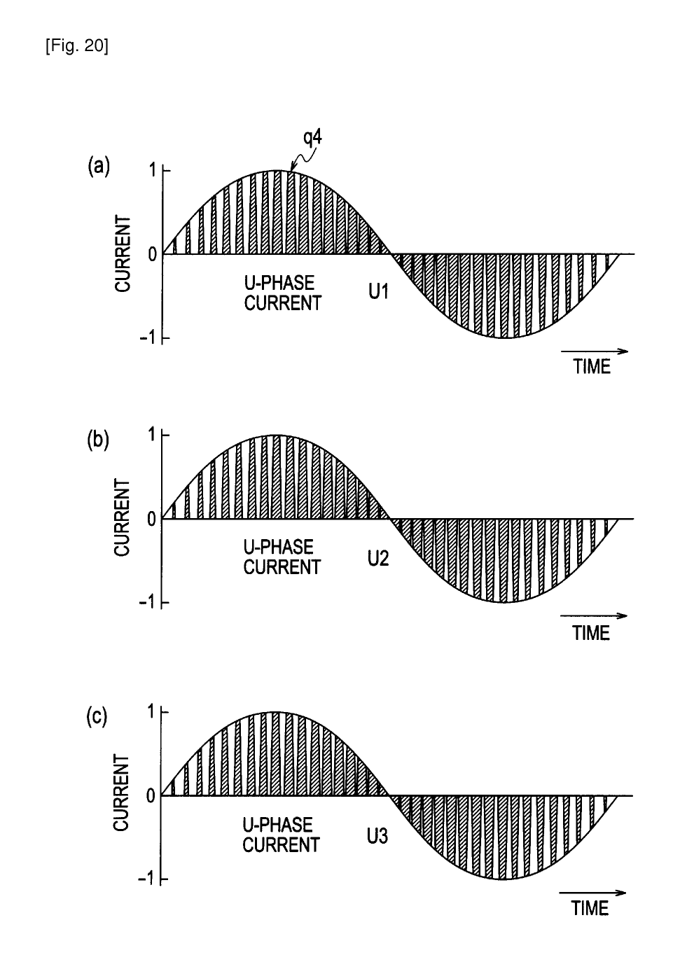

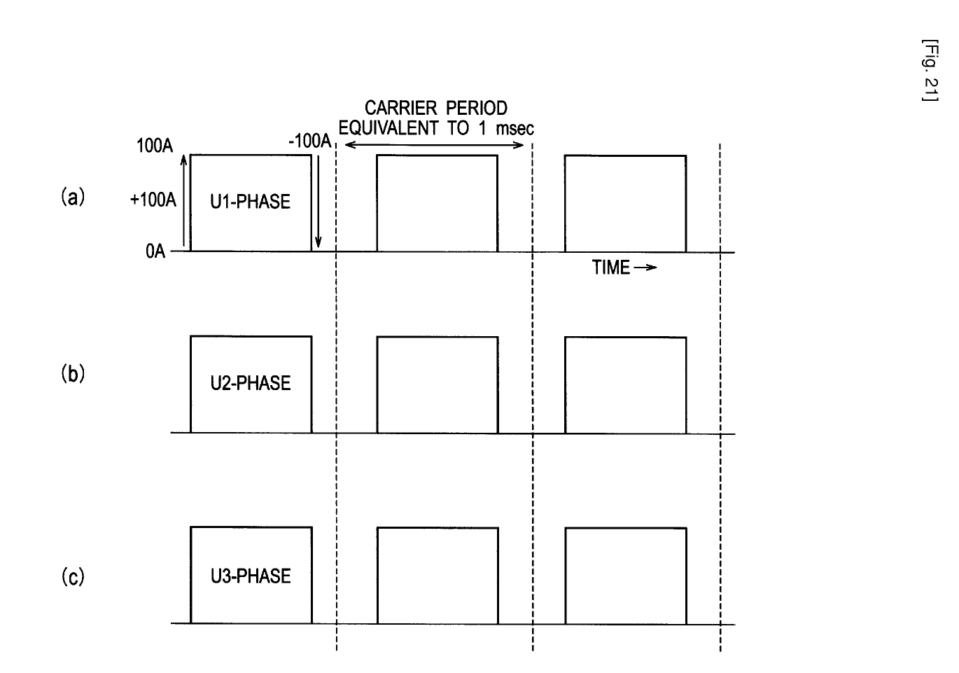

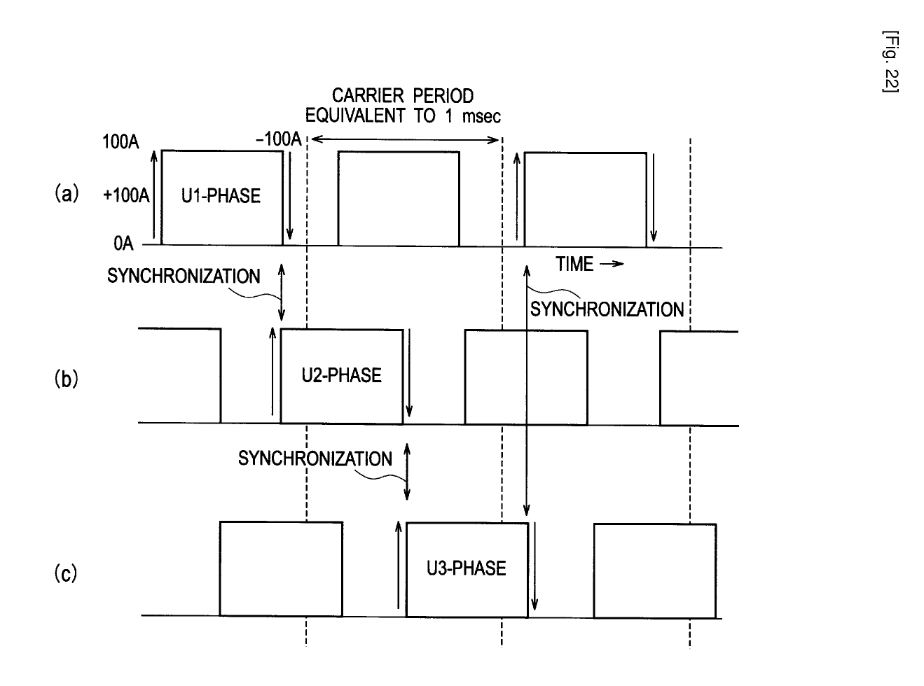

FIGS. 20(a) to 20(c) are waveforms when U-phase currents are output using the switching elements of three systems, and show each current of U1-phase, U2-phase and U3-phase. At the point indicated by the reference numeral q4 in FIG. 20, the current pulses of the respective U1, U2 and U3 phases are output at the same level and at the same timing, as shown in FIGS. 21(a) to 21(c). According to the second embodiment, the on/off timings of such current pulses are shifted, thereby counteracting the current fluctuations.

FIG. 22 is an explanatory diagram showing the output timings of the current pulses of the respective phases (U1, U2 and U3) in the case of shifting the phases. In this method, the off-timing of the U1-phase shown in FIG. 22(a) is synchronized with the on-timing of the U2-phase shown in FIG. 22(b), the off-timing of the U2-phase is synchronized with the on-timing of the U3-phase shown in FIG. 22(c), and the off-timing of the U3-phase is synchronized with the on-timing of the U1-phase.

Due to such a method, when a plurality of the current pulses are generated in each phase (U-phase, V-phase, W-phase) to operate the inverter, the on/off timings of the pulse currents in each phase can be synchronized with each other. Accordingly, the current fluctuations can be substantially counteracted, and a generation of high surge voltage caused by rapid current fluctuations can be prevented.

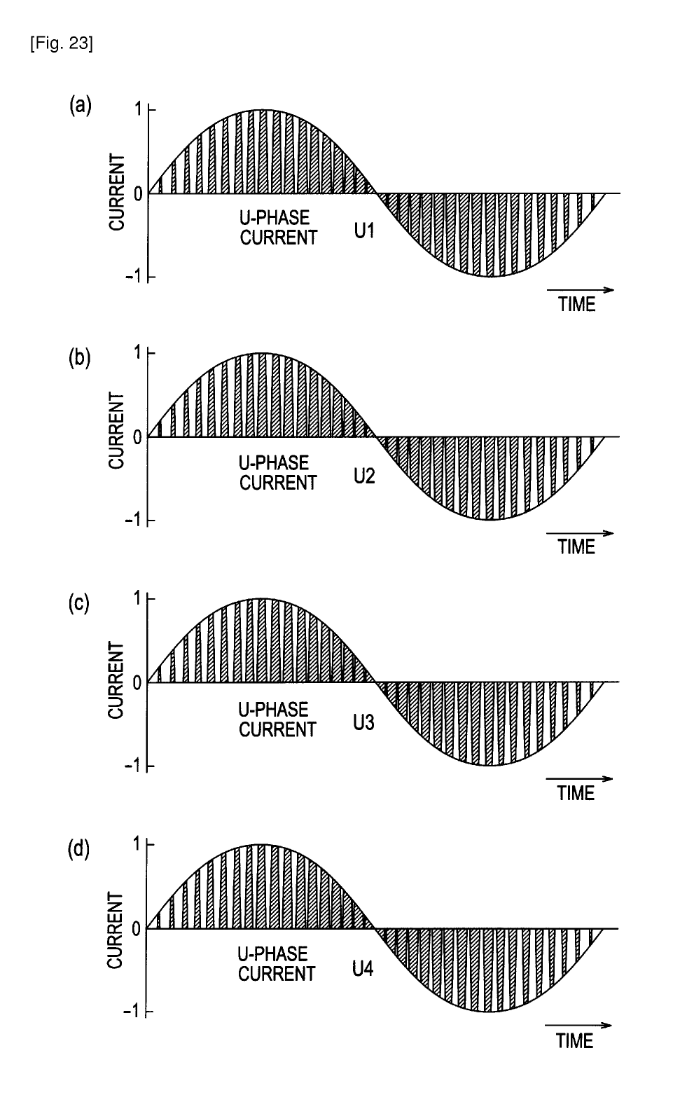

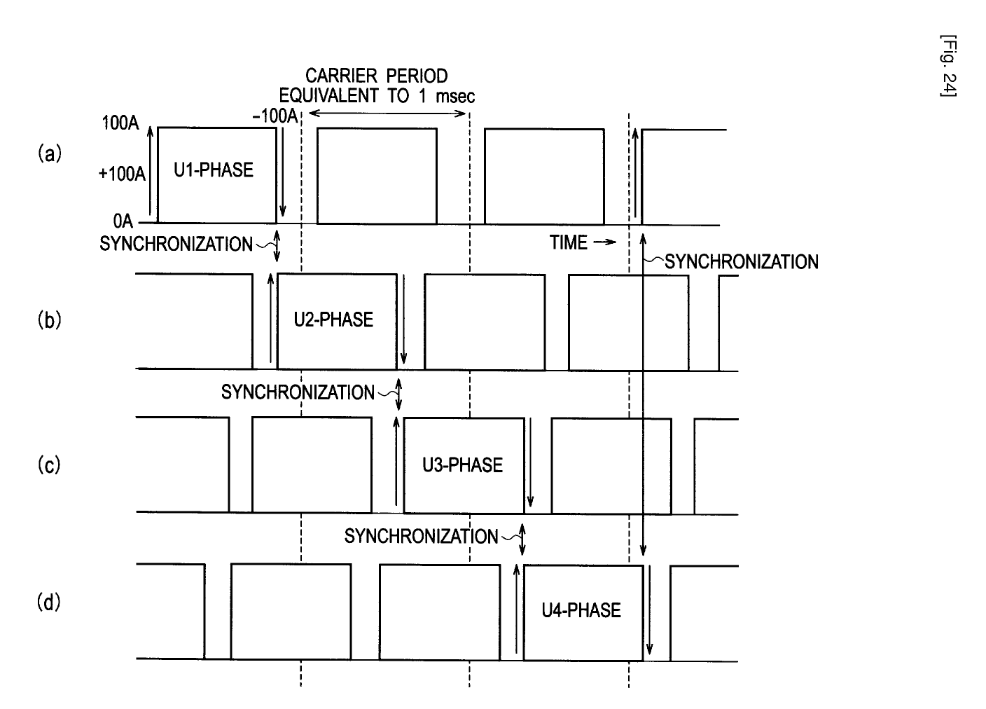

FIG. 22 is the example using the current pulses of the three phases of U1, U2 and U3 for the U-phase as described above. Alternatively, as shown in FIGS. 23(a) to 23(d), the switching elements for one phase may be composed of four-parallel systems (U1-phase, U2-phase, U3-phase and U4-phase), so that the on/off timings of the four phases (U1-phase, U2-phase, U3-phase and U4-phase) are synchronized with each other. Accordingly, current fluctuations of the respective phases can be counteracted in a similar manner to the case of FIG. 22. Note that, although the on-timing of the U1-phase and the off-timing of the U4-phase are synchronized with each other in the same phase in FIG. 24, each timing may be synchronized with the on/off timings in the other phases depending on the duty cycles.

As described above, the power converting apparatus 100 according to the second embodiment shifts the timings of the drive pulses in one phase so as to prevent current fluctuations. In this embodiment, the values of currents flowing in the switching elements in the same phase are identical. Therefore, when one switching element is turned on, another switching element that drives current in the same phase is controlled to be off, so that a generation of surge voltage can be prevented more effectively.

### Third Embodiment

Next, the power converting apparatus 100 of the third embodiment according to the present invention will be described. As shown in FIG. 3(e) described above, one drive pulse is divided into a plurality of drive pulses (for example, two drive pulses), and then the timing of one of the drive pulses is synchronized with the timing of another drive pulse, so as to suppress current fluctuations.

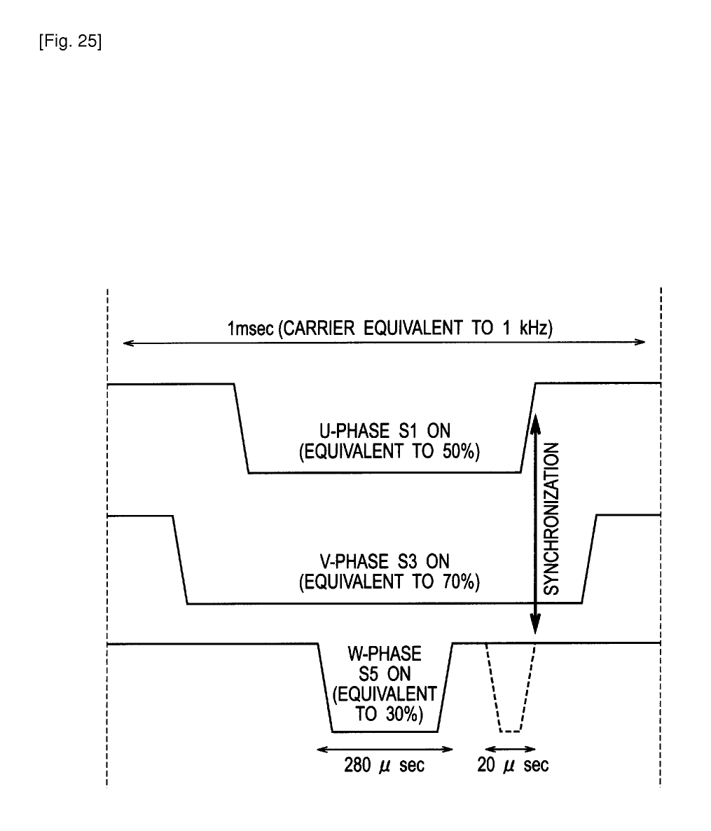

When the drive pulses are shifted, the continuous timing correspondence between the respective phases or in the same phase is complicated. Thus, it may be difficult to synchronize the timing at which one phase (for example, U-phase) is turned off with the timing at which another phase (for example, W-phase) is turned on. In view of this, as shown in FIG. 25, the duty cycle of the upper drive pulse of the W-phase is divided into two drive pulses. In the case shown in FIG. 25, the upper switching element S5 of the W-phase is turned on and off immediately before the upper switching element S1 of the U-phase is turned off. Accordingly, current fluctuations of the upper and lower arm bridges of the U-phase and the upper and lower arm bridges of the W-phase can be suppressed, so that the timings are easily synchronized with each other.

Therefore, in the power converting apparatus according to the third embodiment, a duty cycle of one drive pulse is divided into a plurality of drive pulses, so that when one switching element is turned on, another switching element is easily controlled to be off. In addition, current fluctuations are counteracted since the flowing directions of the respective currents are changed in opposite directions, so that a generation of surge voltage can be easily suppressed. Accordingly, the surge voltage can be reduced while maintaining a desired demand output without changing the duty cycles. Moreover, one drive pulse is divided into a plurality of drive pulses, so that synchronization with a carrier signal can be improved, and an influence on demand output can be extremely minimized.

Although the power converting apparatus of the present invention has been described referring to the embodiments shown in the figures, the invention is not limited to the foregoing embodiments, and each component can be replaced with an arbitrary component having a similar function.

In the above-described embodiments, the case of generating three-phase AC using the PWM-type inverter was described, for example. However, the present invention is applicable for other cases of generating three-phase AC using inverters other than the PWM type, or multiple-phase DC/DC converters.

The embodiments explained hereinabove are only examples described for the purpose of facilitating the understanding of the present invention. The present invention is not limited to the embodiments. Each element disclosed in the above-described embodiments, any combination of the above-described embodiments, modifications and changes belonging to the technical scope of the present invention.

This application is based upon and claims the benefit of priority from the prior Japanese Patent Application No. 2010-093149 filed on Apr. 14, 2010, and the entire contents of these applications are incorporated herein by reference.

### INDUSTRIAL APPLICABILITY

According to the power converting apparatus of the present invention, the power converting apparatus controls the switching elements in such a manner that a direction of current fluctuation when a switching element of one phase is operated is opposite to a direction of current fluctuation when an element of another phase is operated. Therefore, a variation of current that includes a parasitic inductance and passes through a current path can be reduced, and surge voltage derived from current fluctuations can be prevented. Accordingly, the power converting apparatus of the present invention is industrially applicable.

1.-13. (canceled)

14. A power converting apparatus, comprising:
a first switching element and a second switching element that are connected in parallel to a common bus bar connected to a DC power source and drive currents of different phases included in a set of multiple-phase AC power from DC power outputted from the DC power source; and
a control unit that controls on/off operations of the first and second switching elements,
wherein the control unit controls the on/off operations in such a manner that a direction of a current fluctuation by the on/off operation of the first switching element is opposite to a direction of a current fluctuation by the on/off operation of the second switching element.

15. The power converting apparatus according to claim 14,
wherein the control unit comprises:
a duty cycle setting unit that sets ON times of the respective first and second switching elements according to at least one of a current directive value and a voltage directive value to be set based on output demands from the first and second switching elements; and
a timing setting unit that sets operation timings of the respective first and second switching elements, and
the timing setting unit sets the operation timings in such a manner that a timing at which the first switching element is turned off is synchronized with a timing at which the second switching element is turned on without changing the ON times.

16. The power converting apparatus according to claim 14,
wherein the control unit comprises:
a duty cycle setting unit that sets ON times of the respective first and second switching elements according to at least one of a current directive value and a voltage directive value to be set based on output demands from the first and second switching elements; and
a timing setting unit that sets operation timings of the respective first and second switching elements, and
the timing setting unit divides the ON time of the second switching element into a plurality of drive pulses, and sets the operation timings in such a manner that a timing at which one of the plurality of the driving pulses is up is synchronized with a timing at which the first switching element is turned off.

17. The power converting apparatus according to claim 14,
wherein the control unit controls the first switching element, in which larger current flows compared with the second switching element, to be turned off when controlling the second switching element to be turned on.

18. The power converting apparatus according to claim 14, further comprising:
two or more switching elements that are connected in parallel to the common bus bar and drive currents in a same phase,
wherein the control unit controls operation timings of the two or more switching elements that drive the currents in the same phase in such a manner that when one of the two or more switching elements that drive the currents in the same phase is turned on, at least one of other switching elements is turned off.

19. A power converting apparatus for converting DC power to be output from a DC power source into a set of multiple-phase AC power, the power converting apparatus comprising:
a first switching element and a second switching element that are connected in parallel to a pair of common bus bars connected to positive and negative electrodes of the DC power source, respectively, and drive currents of different phases; and
a control unit that controls on/off operations of the first and second switching elements,
wherein the control unit controls the on/off operations in such a manner that a direction of a current fluctuation by the on/off operation of the first switching element is opposite to a direction of a current fluctuation by the on/off operation of the second switching element.

20. The power converting apparatus according to claim 19,
wherein the control unit comprises:
a voltage directive value setting unit that sets a voltage directive value according to a demand of a load;
a PWM control unit that compares the voltage directive value with a carrier to be set according to the load, and sets ON times of the respective first and second switching elements based on a comparison result of the voltage directive value with the carrier; and
a timing setting unit that sets operation timings of the respective first and second switching elements, and
the timing setting unit sets the operation timings in such a manner that a timing at which the first switching element is turned off is synchronized with a timing at which the second switching element is turned on without changing the ON times.

21. The power converting apparatus according to claim 20,
wherein a duty cycle of the second switching element is smaller than a duty cycle of the first switching element, and
the timing setting unit shifts an output timing of a drive pulse of the second switching element so as to synchronize the timing at which the second switching element is turned on with the timing at which the first switching element is turned off.

22. The power converting apparatus according to claim 19,
wherein the control unit comprises:
a voltage directive value setting unit that sets a voltage directive value according to a demand of a load;
a PWM control unit that compares the voltage directive value with a carrier to be set according to the load, and sets ON times of the respective first and second switching elements based on a comparison result of the voltage directive value with the carrier; and
a timing setting unit that sets operation timings of the respective first and second switching elements, and
the timing setting unit divides the ON time of the second switching element into a plurality of drive pulses, and sets the operation timings in such a manner that a timing at which one of the plurality of the driving pulses is up is synchronized with a timing at which the first switching element is turned off.

23. The power converting apparatus according to claim 22,
wherein a duty cycle of the second switching element is smaller than a duty cycle of the first switching element.

24. The power converting apparatus according to claim 19,
wherein the control unit controls the first switching element, in which larger current flows compared with the second switching element, to be turned off when controlling the second switching element to be turned on.

25. The power converting apparatus according to claim 19, further comprising:
two or more switching elements that are connected in parallel to the pair of the common bus bars and drive currents in a same phase,
wherein the control unit controls operation timings of the two or more switching elements that drive the currents in the same phase in such a manner that when one of the two or more switching elements that drive the currents in the same phase is turned on, at least one of other switching elements is turned off.

26. A power converting apparatus, comprising:
a first switching means and a second switching means for driving currents of different phases; and
a control means for controlling on/off operations of the first and second switching means,
wherein the control means control the on/off operations in such a manner that a direction of a current fluctuation by the on/off operation of the first switching means is opposite to a direction of a current fluctuation by the on/off operation of the second switching means.
